(19) United States
(12) Patent Application Publication
(10) Pub. No.: US 2026/0357772 A1
(43) Pub. Date: Nov. 12, 2026

(54) FUEL SUPPLY SYSTEM WITH A FUEL DISTRIBUTION DEVICE FOR SUPPLYING AN INTERNAL COMBUSTION ENGINE WITH GASEOUS FUEL

(71) Applicant: Robert Bosch GmbH, Stuttgart (DE)

(72) Inventors: Gerd Teike, Ditzingen (DE); Ingo Rettig, Schwieberdingen (DE); Manuel Wacker, Oberstenfeld (DE); Markus Schetter, Ebersbach (DE); Markus Rueckle, Stuttgart (DE); Stefan Pfuhl, Markgroeningen (DE); Stephan Wehr, Heiligenstadt (DE)

(21) Appl. No.: 19/132,006

(22) PCT Filed: Oct. 17, 2023
(86) PCT No.: PCT/EP2023/078797

§ 371 Date: Jul. 22, 2025

(30) Foreign Application Priority Data
Dec. 2, 2022 (DE) 10 2022 213 025.1

(51) Int. Cl. F02M 21/02

(52) U.S. Cl. CPC F02M 21/0242; F02M 21/0206; F02M 21/0248

(57) ABSTRACT

Fuel supply system with at least one fuel distribution device for supplying an internal combustion engine with gaseous fuel, in particular hydrogen. The fuel distribution device includes at least one injector connector, to which injectors for injecting the fuel into combustion chambers of the internal combustion engine can be connected, at least one connector, to which a supply line for feeding gaseous fuel into the fuel distribution device can be connected, and a distribution chamber, which is fluidically disposed between the injector connectors and the connector. A storage volume is provided, and a valve device, in particular a shut-off valve device, which is at least indirectly fluidically disposed between the storage volume and the distribution chamber, is provided.

### FIELD

The present invention relates to a fuel supply system with a fuel distribution device for supplying an internal combustion engine with gaseous fuel, in particular hydrogen.

### BACKGROUND INFORMATION

Certain fuel supply systems for supplying an internal combustion engine with gaseous fuel, for example hydrogen, are generally available in the market. Such an internal combustion engine can, for instance, be used to drive motor vehicles. The hydrogen can be stored in liquid form in a tank-like fuel reservoir under relatively high pressure, for instance, for example 700 bar. From there, it makes its way via a high-pressure pressure control device to a low-pressure pressure control device and on to a fuel distribution device that is functionally similar to the conventional fuel rail in an internal combustion engine with gasoline or diesel direct injection. The high-pressure pressure control device typically down regulates the gas pressure to approximately 40-50 bar, for example; the low-pressure pressure control device further down regulates the gas pressure-typically to a pressure of approximately 10-20 bar. The fuel distribution device typically has one injector or multiple injectors connected to it, which inject the gaseous fuel directly into combustion chambers of the internal combustion engine (H2 direct injection) or into a prechamber (port fuel injection).

The fuel supply system typically includes a safety valve. The safety valve is embodied as a shut-off valve device. When the internal combustion engine is switched off, the shut-off valve device is closed and the shut-off valve device opens when the internal combustion engine is to be started. In the event of a leak, the shut-off valve device is intended to prevent an unwanted escape of gas into the fuel distribution device or out of the injectors when the internal combustion engine is switched off.

Fuel injection systems for gaseous fuels also have special requirements. Measures that are used in fuel rails for liquid fuels can therefore be particularly disadvantageous in applications for gaseous fuels.

According to an internal and not necessarily published level of development of the applicant, a pressure control valve can be used in H2-combustion engines for H2 direct injection or port fuel injection between the tank and the rail. This regulates the pressure and thus the mass flow into a connected rail as required. Depending on the size of the required volumetric flow, the pressure control valve can be embodied with one or two modified proportional valves. The two proportional valves can be seated in a housing made of an aluminum block installed in parallel between the inlet pressure and the outlet pressure. A pressure sensor can usually also be seated in the housing for the pressure control valve. Additional safety valves can moreover further be installed, that are also mounted on a safety valve disposed upstream of the pressure control valve.

According to such an internal and not necessarily published level of development, in H2 combustion engines, the pressure of the hydrogen volume stored in the rail is set by a pressure controller disposed upstream of the rail. For this purpose, the pressure at the pressure controller is measured and the hydrogen is passed through a metering unit to the rail volume in accordance with the current system requirements. To determine the required amount of hydrogen, the pressure and the temperature are typically measured in the storage volume of the rail and evaluated accordingly. In particular in H2-combustion engines with direct injection, for example, not only the hydrogen volume upstream of the pressure controller but also the H2 volume enclosed in the rail can be specifically shut off after the engine is switched off. This is to prevent hydrogen from escaping via the injectors. This could otherwise lead to the formation of an ignitable mixture, which has to be prevented for safety reasons. To do this, the H2 volume in the rail can be shut off by shut-off units (safety valves) directly on the individual injectors, for example.

In another possible arrangement according to such an internal and not necessarily published level of development, the individual shut-off units can also be disposed directly on injector connectors on the rail.

### SUMMARY

A fuel supply system according to the present invention may have the advantage that it enables improved design and operation. It can in particular produce the advantage that a structure with less complexity and/or with a reduced number of components is possible.

Advantageous further developments of the fuel supply system disclosed herein are made possible by the measures disclosed herein.

The fuel supply system of the present invention is especially suitable for hydrogen injection applications. During operation, the injectors (fuel injection valves) can inject the gaseous fuel needed for the combustion process, in particular hydrogen, into the respective combustion chamber of the internal combustion engine at a suitable pressure.

The internal combustion engine is not a component of the fuel supply system according to the present invention. The fuel supply system according to the present invention can in particular also be manufactured and marketed independently of an internal combustion engine.

The use of individual shut-off units for each injector, which is associated with considerable technical effort and corresponding costs, is not necessary. This makes it possible to simplify the system. At the same time, it also enables the use of only one shut-off unit for all injectors.

An optionally provided high-pressure pressure control device typically down regulates the gas pressure to approximately 40-50 bar, for example; an optionally provided low-pressure pressure control device further down regulates the gas pressure-typically to a pressure of approximately 10-20 bar. The low-pressure pressure control device controls the pressure and thus the mass or volumetric flow in the distribution chamber or to the distribution chamber of the fuel distribution device in accordance with the specific requirements. At least one pressure control valve, typically a proportional valve, which can be a component of the low-pressure pressure control device, can be provided for this purpose.

According to an example embodiment of the present invention, it is advantageous that exactly one shut-off valve device is provided. The number of shut-off valve devices can thus optimally be selected to be small. This reduces the complexity and optimizes manufacturing costs.

According to an example embodiment of the present invention, it is advantageous that the storage volume at least functions as a reservoir for the gaseous fuel and that the distribution chamber at least substantially has the function of distributing fuel via the injector connectors to the injectors. This at least substantially enables a separation of functions between a reservoir for the fuel and a distribution of the fuel. The distribution chamber then does not have the function of fuel storage.

According to an example embodiment of the present invention, it is advantageous if the shut-off valve device comprises an intake, via which an at least approximately radial inflow of gaseous fuel at least indirectly from the storage volume into a housing of the shut-off valve device is enabled, and/or that the shut-off valve device comprises an outlet, via which an at least approximately radial outflow of gaseous fuel from a housing of the shut-off valve device at least indirectly into the distribution chamber is enabled. This makes it possible to achieve an advantageous arrangement that enables an advantageous integration of the storage volume into the fuel distribution device or an advantageous connection to the fuel distribution device. Similar advantages result from other arrangements of the shut-off valve device on system components of the fuel supply system.

According to an example embodiment of the present invention, it is advantageous if the storage volume is integrated into the fuel distribution device and/or that the shut-off valve device is connected to the fuel distribution device, in particular connected to the fuel distribution device by means of welding and/or soldering and/or screwing. This enables a compact and space-saving design.

According to an example embodiment of the present invention, it is advantageous if the storage volume is disposed separately from the fuel distribution device. This makes it possible to optimize the space requirements of the fuel distribution device. The length of the fuel distribution device can therefore optionally be selected to be optimally short.

According to an example embodiment of the present invention, it is advantageous if the shut-off valve device is disposed between the storage volume and the fuel distribution device. One shut-off valve device may be sufficient to prevent the formation of an ignitable mixture after the internal combustion engine has been switched off.

According to an example embodiment of the present invention, it is advantageous if a pressure controller is provided and that the shut-off valve device is disposed between the pressure control device and the fuel distribution device. It is advantageous that the storage volume is integrated into a pressure control device. This enables an optimum arrangement of the components. Depending on the application, the shut-off valve device can be disposed directly on the fuel distribution device, directly on the pressure control device or in a fuel line between the pressure control device and the fuel distribution device, for instance.

According to an example embodiment of the present invention, it is advantageous if a metering unit is provided, which is integrated into a pressure control device. This enables further integration, so that the complexity of the system in terms of the number of components can be further reduced.

According to an example embodiment of the present invention, it is advantageous if a distribution volume of the distribution chamber is selected to be so small that the volumes, which can be separated fluidically by means of the shut-off valve device after the shut-off valve device, including the distribution volume, up to the injectors, accommodate a maximum quantity of gaseous fuel, in particular hydrogen, at which maximum quantity an escape of the gaseous fuel from these volumes via the injectors does not lead to the formation of an ignitable mixture. The shut-off valve device can therefore reliably function as a safety valve.

Depending on the configuration, one or more of the following functionalities and advantages can be achieved. To avoid the described formation of an ignitable mixture by escaping hydrogen, the possible H2 concentration can be limited. This can be achieved by accordingly reducing the hydrogen volume that could escape via the injectors.

For this purpose, a special division of the system functions and the H2 volume can be provided. The rail no longer needs to contain the H2 storage volume, but may serve only to distribute the hydrogen to the individual injectors. The H2 volume in the rail is preferably designed to be so small that potential escape of the remaining hydrogen no longer leads to the formation of an ignitable mixture and the safety requirements can be met.

Preferably, only one shut-off unit for the H2 volume in the rail is needed. The individual shut-off units in front of each injector can be omitted. The complexity and cost of the system can be reduced.

The requirements for the shut-off valve, which serves as a safety valve, are preferably to open as a switching valve against high pressure and to have as low a holding current as possible when it is open. The quantity control valve can be used as a 2-stage valve with a pilot seat, wherein the valve seat and optionally a connecting piece can be integrated into a housing. Modular mounting to different components, such as a pressure control valve or a fuel distribution device, can thus easily be made possible. It in particular also makes it possible to avoid the disadvantage of two (or more) safety valves, one in the pressure control valve and the other in the fuel distribution device. If the volume downstream of the safety valve is sufficiently small, only one valve placed in the rail may be enough on the system side. Specifically, it can be proposed that a rail combines a large storage volume and a small distribution volume which are connected by the safety valve. The storage volume can in particular be integrated into the rail in terms of structure and separated from the distribution volume by the safety valve. A safety valve can possibly be omitted on the system side, because the safety valve can be placed in the fuel distribution device, which leaves only a small distribution volume.

### BRIEF DESCRIPTION OF THE DRAWINGS

Preferred embodiment examples of the present invention are explained in more detail in the following description with reference to the figures in which corresponding elements are provided with the same reference signs.

FIG. 1 shows a schematic illustration of a fuel supply system for supplying an internal combustion engine with gaseous fuel comprising, among other things, a fuel distribution device and a shut-off valve device, according to an example embodiment of the present invention.

FIG. 2 shows a perspective view of a fuel distribution device and the shut-off valve device of FIG. 1 according to one possible configuration of the present invention.

FIG. 3 shows a sectional view of a fuel distribution device and the shut-off valve device of FIG. 1 according to the possible configuration of the present invention.

FIG. 4 shows a longitudinal section through the fuel distribution device and the shut-off valve device of FIG. 1 according to the possible configuration of the present invention.

FIG. 5 shows a schematic illustration of another possible configuration of the fuel supply system, according to the present invention.

FIG. 6 shows a schematic illustration of another possible configuration of the fuel supply system, according to the present invention.

FIG. 7 shows a schematic illustration of another possible configuration of the fuel supply system, according to an example embodiment of the present invention.

FIG. 8 shows a schematic illustration of a modified configuration of the fuel supply system shown in FIGS. 2 and 3, according to an example embodiment of the present invention.

### DETAILED DESCRIPTION OF EXAMPLE EMBODIMENTS

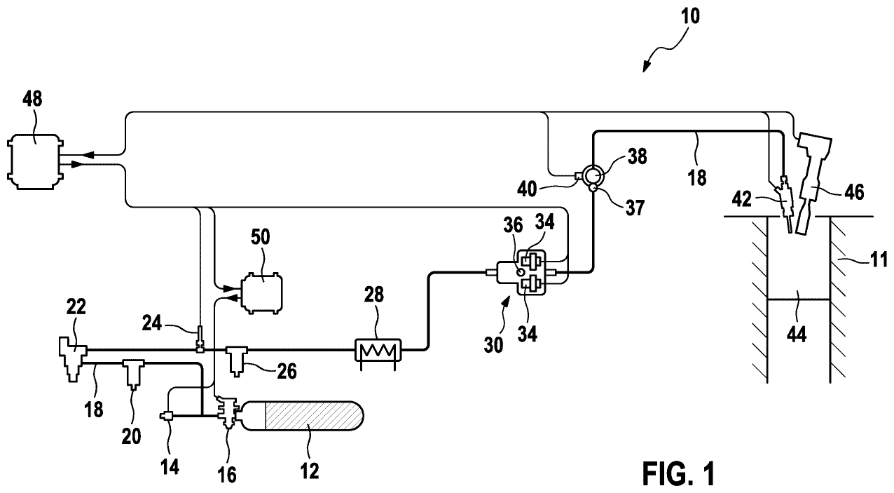

A fuel supply system is labeled overall in FIG. 1 with the reference sign 10. It serves to supply an internal combustion engine 11 with an in particular gaseous fuel, in the present case for example gaseous hydrogen. The hydrogen is stored in liquid form in a tank-like fuel reservoir 12 under high pressure, for example 700 bar. Said reservoir can be filled via a filling connector 14. Also disposed on the fuel reservoir 12 is an integrated unit 16 consisting of a tank valve for filling and dispensing hydrogen into or out of the fuel reservoir 12, and a temperature sensor for acquiring the temperature of the gaseous hydrogen coming out of the fuel reservoir 12.

The gaseous hydrogen first passes through a pressure line 18 to a filter 20 and from there to a high-pressure pressure control device 22. This reduces the pressure of the gaseous hydrogen, for example to a pressure in the range of 40-50, in particular approximately 44 bar. The pressure line 18 leads from the high-pressure pressure control device 22 on to a pressure sensor 24, a further filter 26, an optional temperature control device 28, and finally to a low-pressure pressure control device 30.

In the present example, the low-pressure pressure control device 30 comprises two hydraulically parallel pressure control valves 34 and a low-pressure pressure sensor 36. The two pressure control valves 34 are identical in structure and are typically proportional valves. The low-pressure pressure control device 30 further reduces the pressure in the pressure line 18 from the input-side pressure of about 40-50 bar in the present example to a pressure of approximately 10-20 bar, for example, in particular approximately 15 bar.

Downstream of the low-pressure pressure control device 30, the pressure line 18 leads to a combined shut-off valve device 37 with a fuel distribution device 38 that can be based on an elongated tubular base body 52, wherein an inner cross-section or inner diameter can vary along the base body. The gas pressure prevailing in at least a portion of the fuel distribution device 38 can be acquired by a pressure sensor 40.

Connected to the fuel distribution device 38 are multiple injectors 42, which, in the present example, inject the gaseous hydrogen directly into combustion chambers 44 of the internal combustion engine 11. The gaseous hydrogen is mixed with atmospheric oxygen in the combustion chambers 44, and this mixture is ignited by a respective ignition device 46. The internal combustion engine 11 is typically a 2-stroke or 4-stroke piston internal combustion engine 11 of a largely conventional design. Such an internal combustion engine 11 is used to drive a motor vehicle, for instance. However, it can also be used in a stationary manner, for example to drive a generator to produce electricity.

The fuel supply system 10 and its components are controlled by an electronic control and regulating device 48 comprising one or more corresponding microprocessors, a memory for program code, etc. Said device receives signals from, among other things, the temperature sensor 16, the pressure sensor 24, the pressure sensor 40, etc. The control and regulating device 48 controls various components of the fuel supply system 10, including the low-pressure pressure control device 30 and the ignition devices 46. The control and regulating device 48 also controls a control device 50, which in turn specifically controls or regulates the operation of the fuel reservoir 12.

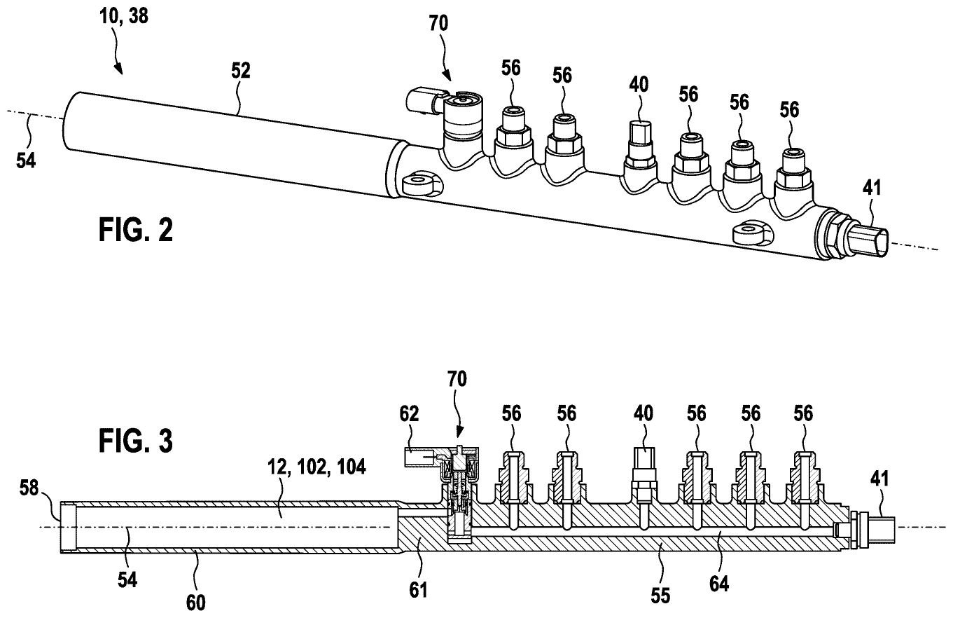

The fuel distribution device 38 will now be explained in more detail with reference to FIGS. 2 to 4. It comprises an overall tubular housing (base body) 52 with a longitudinal axis 54, a section 55 and, in the present example, a total of five injector connectors 56 in the section 55, wherein an injector 42 can be connected to each injector connector 56. The injector connectors 56 here are configured as screw sockets that extend orthogonally to the longitudinal axis 54 in the radial direction. The pressure sensor 40 is disposed radially on the housing 52 at a suitable location in the figures.

The fuel distribution device 38 further comprises a connector 58 to which pressure line 18 for supplying the gaseous fuel to the fuel distribution device 38 can connected as appropriate (not shown). The connector 58 is disposed here on a section 60 of the housing 52 and, in the present example, extends axially with respect to the longitudinal axis 54 of the tubular housing 52 and thus perpendicular to the injector connectors 56. The section 60 is separated from the section 55 by an intermediate region 61.

As will be explained in even more detail below, the shut-off valve device 37 is disposed and mounted on the intermediate region 61 of the housing 52 in this embodiment example. An electrical connector 62 of the shut-off valve device 37 is disposed coaxially to the longitudinal axis 54 and extends here in the same direction as the connector 58. In a not depicted embodiment, the electrical connector can also extend diametrically opposite to the connector 58, or radially or in any other direction.

The shut-off valve device 37 can separate a distribution chamber 64 from the connector 58. This makes it possible to prevent an unwanted escape of gas from the pressure line 18 if there is a leak, for example at one of the injectors 42 and/or the distribution chamber 64.

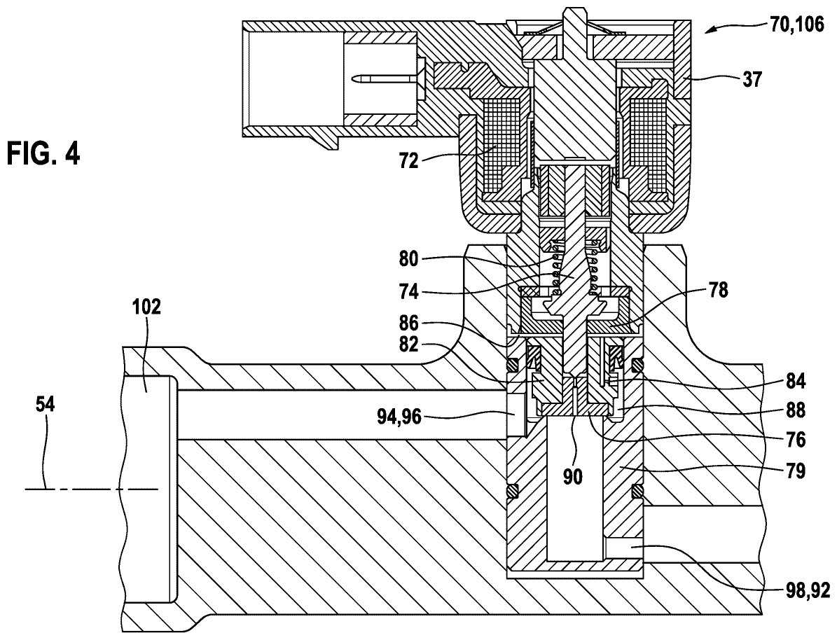

The arrangement and configuration of the shut-off valve device 37 will now be explained in more detail with reference to FIG. 4. It should be noted, however, that the structural design of the shut-off valve device 37 is to be understood here merely as an example. In other not depicted embodiments, the shut-off valve device 37 can be structurally different. Typically, however, it is closed without current and is designed in such a way that only a relatively small amount of electrical energy is required to keep open.

FIG. 4 shows a longitudinal section through the fuel distribution device 38 and the shut-off valve device 37 of FIG. 1.

The two-stage valve 70 of the shut-off valve device 37 operates as follows, for example. The pilot seat first opens as a result of the needle moving upward when current is supplied to the coil 72, then the main seat opens. The tip of the needle 74 functions as the valve body for the pilot seat; the valve piece 76 functions as the sealing seat. The valve piece 76 is made of a sealing material. This can be an elastomer, PEEK, or Vespel material. The valve piece 76 functions as the valve body for the main seat; a further housing (housing part) 79 of the valve 70 forms the integrated interface for the valve seat.

In the resting state, the coil 72 is not supplied with current; the spring 80 presses the needle 74 into the valve seat of the valve piece 76 and thus the valve piece 76 against the valve seat on the housing 78. The valve piece 76 is pressed into the sleeve 82. The sleeve 82 is disposed in the housing 79 such that it can move along the valve axis of the valve 70.

The pressure in the control chamber 86 and the working chamber 88 is balanced. The control chamber 86 is sealed from the working chamber 88 by the dynamic seal mounted on the sleeve 82. The control chamber 86 is pneumatically connected via the intake throttle (Z-throttle) 84.

When the coil 72 is supplied with current, the magnet pulls the needle 74 upward, thereby releasing the pilot valve seat. The gas flows from the control chamber 86 through the outflow throttle (A-throttle) 90 toward the outlet 92. This reduces the control chamber pressure relative to the working chamber 88. Because the diameter of the Z-throttle 84 is smaller than the diameter of the A-throttle 90, this state is maintained. Because the working chamber pressure is greater than the control chamber pressure, the sleeve 82 with the valve piece 76 is pushed upward in the housing 79; the main valve seat, which is integrated into the housing 79 of the valve 70, is released.

Integration into a fuel distribution device 38, which also serves as an H2 rail, according to the possible configuration is shown, among others, in FIGS. 3 and 4. The valve 70, which serves as a safety valve, with its valve housing 78 and the housing extension formed by the additional housing 79 in the intermediate region 61, is mounted in the fuel distribution device 38 between the large and the small volume. The flow into the valve 70, which serves as a safety valve, take place in the upper bore 94 that represents an intake 96; the outflow takes place with the lower bore 98, which serves as the outlet (drain) 92. The lower O-ring of the valve 70 ensures the seal between the intake 96 and the outlet 92. The upper O-ring ensures gas tightness to the environment. In this configuration, the valve assembly can preferably either be screwed or welded into the fuel distribution device 38, which can be done using a laser or a KEEP process. For the sake of simplicity, the fuel distribution device 38 is embodied here as a 5-cylinder solution with five HD connecting pieces (injector connectors) 57, in which case a pressure and/or a temperature sensor 40, 41 can be provided as well. However, modifications to any number of cylinders are possible.

The fuel supply system 1 thus comprises the fuel distribution device 38 for supplying the internal combustion engine 11 with gaseous fuel, in particular hydrogen. In this embodiment example, the fuel distribution device 38 comprises a plurality of injector connectors 56 to which the injectors 42 for injecting fuel into combustion chambers 44 of the internal combustion engine 11 are connected. Exactly one connector 58 is provided as well, to which the supply line 18 for feeding gaseous fuel into the fuel distribution device 38 is connected. The distribution chamber is fluidically located between the injector connectors 56 and the connector 58.

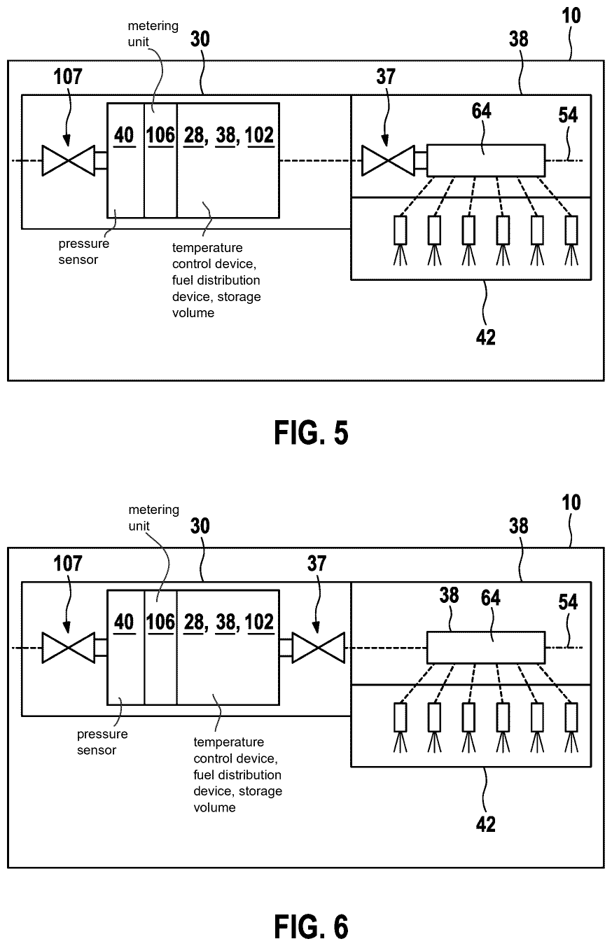

A storage volume 102 is provided as well. The valve device 37 serves as a shut-off valve device 37 between the distribution chamber 64 and the storage volume 102. The shut-off valve device 37 here is at least indirectly fluidically disposed between the storage volume 102 and the distribution chamber 64, wherein the shut-off valve device 37 in this embodiment example is disposed directly between the distribution chamber 64 and the storage volume 102. Modifications in which there is only an indirect arrangement are also described in more detail with reference to FIG. 5 to 7. In this embodiment example, exactly one shut-off valve device 37 is provided.

In particular during operation, the storage volume 102 functions as a reservoir 104 for the gaseous fuel, whereas the distribution chamber 64 at least substantially has the function of distributing fuel via the injector connectors 56 to the injectors 42. However, the pressure and/or the temperature can still be measured at the distribution chamber 64, for which suitable connections for a pressure sensor 40 or temperature sensor 41 can be configured.

An approximately radial inflow of gaseous fuel from the storage volume 102 into the housing 79 of the shut-off valve device 37 is possible via the intake 96. Moreover, an approximately radial outflow of gaseous fuel from the housing 79 of the shut-off valve device 37 into the distribution chamber 64 is possible via the outlet 92.

The storage volume 102 is integrated into the fuel distribution device 38 in this embodiment example. The shut-off valve device 37 is connected to the fuel distribution device 38. The connection can be achieved by welding or soldering. A screw connection is possible, too.

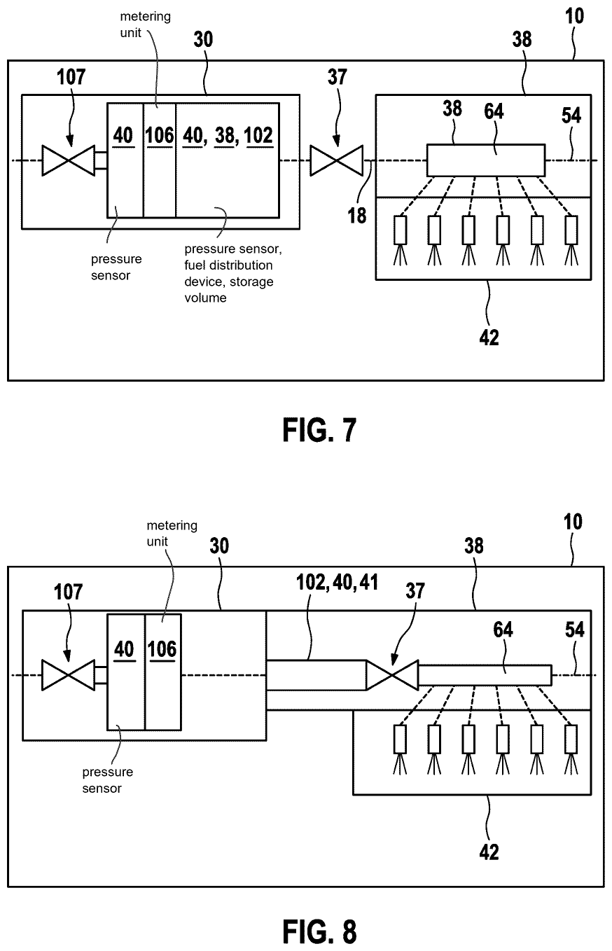

FIG. 5 shows a schematic illustration of another possible configuration of the fuel supply system 10. The storage volume 102 is disposed separately from the fuel distribution device 38 here. The shut-off valve device 37 is furthermore disposed between the storage volume 102 and the fuel distribution device 38. The shut-off valve device 37 is disposed directly on the tubular housing 52 of the fuel distribution device 38. The storage volume 102 can be integrated into the pressure control device 30. A metering unit 106 is provided as well and is integrated into the pressure control device 30. A further shut-off unit 107, which can be configured as a shut-off valve 107 or shut-off valve device 107, is optionally provided in FIG. 5 (and correspondingly also in FIGS. 6 and 7). This further shut-off unit 107 is preferably omitted.

In a preferred arrangement of the shut-off valve device 37 in the H2 system, in which the storage volume 102 is disposed in the pressure control device 30, the pressure and temperature measurement can be carried out there. For this purpose, the pressure sensor 40 and the temperature sensor 41 are then likewise moved into the pressure control device 30. Due to this division of the individual volumes, it is sufficient to provide only one shut-off valve device 37 upstream of the reduced rail volume of the fuel distribution device 38. The shut-off valve device 37 is shown here as an example disposed directly on the fuel distribution device 38.

FIG. 6 shows a schematic illustration of another possible configuration of the fuel supply system 10. In this system diagram, the shut-off valve device 37 for all injectors 42 is disposed directly on the pressure control device 30.

FIG. 7 shows a schematic illustration of another possible configuration of the fuel supply system 10. In this system diagram, the shut-off valve device 37 for all injectors 42 is disposed in the pressure line 18 between the pressure control device 30 and the fuel distribution device 38.

FIG. 5 to 7 thus describe configurations in which the shut-off valve device 37 is respectively disposed between the pressure control device 30 and the fuel distribution device 38. Depending on the system requirements, the pressure and temperature measurement can alternatively or additionally also be disposed in the fuel distribution device 38.

In the embodiments described with reference to FIG. 1 to 7, a distribution volume 108 of the distribution chamber 64 is selected to be so small that the volumes, which can be separated fluidically by means of the shut-off valve device 37 after the shut-off valve device 37, including the distribution volume 108, up to the injectors 42, accommodate a maximum quantity of gaseous fuel, in particular hydrogen, at which maximum quantity an escape of the gaseous fuel from these volumes via the injectors 42 does not lead to the formation of an ignitable mixture.

FIG. 8 shows a schematic illustration of a modified configuration of the fuel supply system 10 shown in FIGS. 2 and 3. The pressure sensor 40 can be provided on the pressure control device 30 and/or on the storage volume 102. The temperature measurement can also be carried out by means of the temperature sensor 41 on the storage volume 102.

The present invention is not limited to the described embodiment examples. Other modifications, in particular combinations of the described modifications, are in particular possible as well.

1-10. (canceled)

11. A fuel supply system, comprising:
at least one fuel distribution device configured to supply an internal combustion engine with gaseous fuel, the fuel distribution device including at least one injector connector to which injectors for injecting the fuel into combustion chambers of the internal combustion engine can be connected, at least one connector to which a supply line for feeding gaseous fuel into the fuel distribution device can be connected, and a distribution chamber which is fluidically disposed between the injector connectors and the connector;
a storage volume; and
a shut-off valve device which is at least indirectly fluidically disposed between the storage volume and the distribution chamber.

12. The fuel supply system according to claim 11, wherein the gaseous fuel is hydrogen.

13. The fuel supply system according to claim 11, wherein the fuel supply system includes exactly one shut-off valve device.

14. The fuel supply system according to claim 11, wherein the storage volume at least functions as a reservoir for the gaseous fuel, and the distribution chamber includes a function of distributing fuel via the injector connectors to the injectors.

15. The fuel supply system according to claim 11, wherein: (i) the shut-off valve device includes an intake, via which an at least approximately radial inflow of gaseous fuel at least indirectly from the storage volume into a housing of the shut-off valve device is enabled, and/or (ii) the shut-off valve device includes an outlet, via which an at least approximately radial outflow of gaseous fuel from the housing of the shut-off valve device at least indirectly into the distribution chamber is enabled.

16. The fuel supply system according to claim 11, wherein: (i) the storage volume is integrated into the fuel distribution device, and/or (ii) the shut-off valve device is connected to the fuel distribution device by welding and/or soldering and/or screwing.

17. The fuel supply system according to claim 11, wherein the storage volume is disposed separately from the fuel distribution device.

18. The fuel supply system according to claim 17, wherein: (i) the shut-off valve device is disposed between the storage volume and the fuel distribution device, and/or (ii) a pressure control device is provided and the shut-off valve device is disposed between the pressure control device and the fuel distribution device.

19. The fuel supply system according to claim 17, wherein the storage volume is integrated into a pressure control device.

20. The fuel supply system according to claim 11, further comprising a metering unit, which is integrated into a pressure control device.

21. The fuel supply system according to claim 11, wherein a distribution volume of the distribution chamber is selected to be so small that volumes, which can be separated fluidically using the shut-off valve device after the shut-off valve device, including the distribution volume, up to the injectors, accommodate a maximum quantity of gaseous fuel at which maximum quantity an escape of the gaseous fuel from the volumes via the injectors does not lead to formation of an ignitable mixture.
